(19) United States
(12) Patent Application Publication
(10) Pub. No.: US 2012/0186976 A1
(43) Pub. Date: Jul. 26, 2012

(54) METAL-SUPPORTED ELECTROCHEMICAL CELL AND METHOD FOR FABRICATING SAME

(75) Inventors: Richard Laucournet, La Buisse (FR); Thibaud Delahaye, Tresques (FR)

(73) Assignee: COMMISSARIAT À L'ÉNERGIE ATOMIQUE ET AUX ÉNERGIES ALTERNATIVES, Paris (FR)

(21) Appl. No.: 13/388,968

(22) PCT Filed: Jul. 28, 2010
(86) PCT No.: PCT/EP2010/060978

§ 371 Date: Apr. 12, 2012

(30) Foreign Application Priority Data
Aug. 3, 2009 (FR) 0955461

(51) Int. Cl. C25B 9/08; B05D 3/02; B05D 5/12

(52) U.S. Cl. 204/252; 427/58

(57) ABSTRACT

A metal-supported electrochemical cell is provided. The cell may contain a porous metal support comprising a first- and a second-main surfaces, a porous thermomechanical adaptive layer on the second main surface, a porous layer that is a barrier against the diffusion of chromium on the porous thermomechanical adaptive layer, this porous barrier layer being in stabilised zirconia and/or substituted ceria, and in a mixed oxide of spinel structure, a porous hydrogen electrode layer on the porous barrier layer, a dense electrolyte layer on the porous hydrogen electrode layer; a dense or porous reaction barrier layer on the dense electrolyte layer, and a porous oxygen or air electrode layer on the reaction barrier layer. A method for fabricating a metal-supported electrochemical cell is also provided. The method may comprise a step for the simultaneous sintering of the green support and of all the previously deposited layers in the green state.

### TECHNICAL FIELD

The invention concerns a Metal-Supported electrochemical Cell or [symbol] MSC [symbol] .

The invention also concerns a method for fabricating a metal-supported electrochemical cell.

The technical field of the invention can be generally defined as the field of new energy technologies particularly intended to reduce greenhouse gas emissions or to promote clean, renewable energy sources.

The technical field of the invention may more particularly be defined as the field of electrochemical cells, and more specifically metal-supported electrochemical cells intended for high temperature applications generally from 600° C. to 900° C. These electrochemical cells may be cells for high-temperature steam electrolysers ( [symbol] HTE [symbol] ) producing hydrogen on a large-scale, or cells of high temperature fuel cell type ( [symbol] SOFC [symbol] —Solid Oxide Fuel Cell) which are supplied with hydrogen or various natural fuels such as natural gas or gases derived from biomass.

In the field of hydrogen production, the first sectors concerned are the reforming and gasification (hydrogenation) sectors of primary carbon fuels such as coal and heavy hydrocarbons, and the traditional petrochemical industry. These are sectors having large-scale production.

The second sectors concerned are those contained within the perspective of the development of hydrogen as energy source, in particular having applications in the field of so-called stationary power generation via the development of systems functioning under cogeneration that are particularly installed in collective dwellings.

Additionally, in the sphere of SOFCs the so-called stationary technology may also allow the functioning with natural gas/town gas or with gas originating from other sources (biogas from landfills or sludge from (wastewater) treatment plants, gas from biomass, etc.) of a cogeneration system which has high global yield possibly exceeding 70%.

### STATE OF THE PRIOR ART

The first generation of high temperature electrolyser cells or of cells of high temperature fuel cells comprised a support formed by the electrolyte, these being called [symbol] ESCs [symbol] for Electrolyte-Supported Cell. Such an electrolyte-supported cell is illustrated in FIG. 1: the O₂ oxygen electrode (1) and the hydrogen or water electrode (2) are arranged either side of the thick electrolyte which forms the mechanical support (3).

The second generation of high temperature electrolyser cells or of cells of high temperature fuel cells comprised a support formed by an electrode and was therefore called an [symbol] Anode-Supported Cell [symbol] ASC in SOFC terminology, or [symbol] Cathode-Supported Cell—CSC [symbol] in HTE terminology. Said [symbol] ASC [symbol] or [symbol] CSC [symbol] electrode-supported cell is illustrated in FIG. 2: the electrolyte (3) and the oxygen electrode (1) are arranged on the thick hydrogen or water electrode (2) which acts as mechanical support.

The third generation of high temperature electrolyser cells or of cells of high temperature fuel cells, which is of more particular interest in the present application, comprises a porous metal support and is therefore called a metal-supported cell or MSC. Such a metal-supported cell may have two configurations which are respectively illustrated in FIGS. 3A and 3B depending on whether the electrode placed in contact with the porous metal support is the hydrogen or water electrode (2) (FIG. 3A) or the oxygen electrode also called the air electrode (1) (FIG. 3B). It is to be noted that the dimensions (thicknesses) mentioned in FIG. 3B are only given as examples. The metal-supported cells shown in FIGS. 3A and 3B comprise four layers (including a metal layer and three ceramic layers), namely:
the porous metal support (4) generally having a thickness of a few mm, even less than 1 mm which ensures:
   mechanical supporting of the cell via its mechanical properties and thickness,
   distribution of the gases, via its porosity, towards the electrode for the electrochemical reactions,
   collection or distribution of current via its electronic conducting metal nature.
the H₂/H₂O electrode (2) which is the anode in SOFC mode and the cathode in HTE mode. On account of the metal support (4), this electrode can be made thinner having a thickness of 40 to 100 μm for example, its resistance to redox cycles is therefore improved and its cost is lower;
the electrolyte (3), an ionic conductor for the O²⁻ ions. The electrolyte 3 can be made thinner, having a thickness of less than 50 μm for example from 10 to 30 μm, its operating temperature can therefore be lowered;
the O₂ electrode also called the air electrode (1) which is the cathode in SOFC mode and the anode in HTE mode. This electrode (1) typically has a thickness of between 40 and 80 μm.

In a standard structure of a metal-supported electrochemical cell, the metal support may have a thickness of a few mm, the hydrogen electrode a thickness of 40 to 100 μm, the electrolyte a thickness of 10 to 30 μm, and the air electrode a thickness of 40 to 80 μm.

The design of [symbol] metal-supported cell [symbol] ( [symbol] MSC [symbol] ) which uses a metal mechanical support on which the electrochemical cell of small, narrow thickness is deposited is therefore able to provide numerous advantages compared with prior generations of [symbol] electrolyte-supported [symbol] or [symbol] electrode-supported [symbol] cells.

The quantities of ceramic materials, the most costly, are effectively reduced to a maximum and performance levels are higher since the thickness of the electrolyte, the most resistive component, is smaller and generally smaller than 50 μm.

Since the hydrogen electrode is thinner than in electrode-supported cells, it is less sensitive to degradation through [symbol] redox [symbol] cycling.

The metal support, a very good heat and electric conductor, prevents any differences in temperature along the X-Y axes of the cell and thereby ensures good current collection.

The resistance to thermal cycles is also improved by good mechanical resistance and good temperature distribution owing to low thermal inertia. The mechanical support is very easy to solder or to join to interconnectors for forming stacks.

The recourse to a metal support, in addition to the expected and previously described technical benefits, also brings a major economic advantage. A technical-economical calculation [1] concluded that a module of 37 $/kWe could be envisaged with this cell design together with low-cost production methods.

In addition, on account of the targeted operating temperature, namely 600-750° C., the stresses on the interconnection materials and the tightness of the future systems using this type of cells could be reduced, and consequently the costs of these systems would also be reduced.

To pay heed to the economic viability of this type of metal-supported cell, the production methods used must exhibit low investment and operating costs, and must allow increased scaling of the cells when used for future industrialization. One of the major challenges of a [symbol] metal-supported [symbol] cell is the depositing of the ceramic layers on the metal substrate using a method which does not modify the microstructure of the metal substrate.

Some teams across the world have started to develop third generation SOFC cells of [symbol] metal-supported [symbol] type.

Nevertheless to date, few studies concern the use of metal-supported cells in [symbol] HTE [symbol] mode. Solely, the Hi₂H₂ European project mentions evaluation works in HTE of cells of [symbol] metal-supported [symbol] type [2].

Documents [3] and [4] mention the use of a vacuum plasma spraying technique for depositing the components of the cell on a porous metal support formed of a chromium-based alloy.

The main advantages put forward for this technology are the possible forming of the three layers in a single operation, without sintering and under non-oxidizing atmospheric conditions which protect the metal support against any oxidation.

However, a large vacuum chamber is required, which makes this method difficult to apply on a mass production scale, and also means that it is of little advantage from a cost reduction viewpoint.

This method also requires substantial, complex parameter optimization to guarantee the desired microstructure characteristics, in particular the control over porosity and good heed of the composition of the composite electrodes.

In most cases, the presence can be noted of microstructural defects such as cracks and porosities in the electrolyte, and hence the onset of stresses which lead to rupture of the electrolyte when operating under high temperature [5]. In addition, it is difficult to prepare an electrolyte of a thickness less than 50 μm and the presence of residual porosity greatly penalizes the extrinsic ion conductivity of this element and hence the global performance of the cell [6].

The reduction in costs of this type of cell was an objective of the European CexiCell project. During their preparation, the anode made of Ni—YSZ and the electrolyte made of YSZ are deposited by atmospheric plasma spraying (APS), which is a technique better adapted to mass production [7], onto a porous substrate made of a Cr—Fe based metal alloy. The LSCF-based cathode is coated on the electrolyte and sintered in situ during the cell start-up.

The work conducted under this project has evidenced the presence of defects at the interface between the porous metal and the anode, thereby penalizing the overall performance of the cell. Micro-cracks were also observed in the electrolyte [8]. Optimizations were carried out, allowing power densities of 500 mW/cm² at 800° C. to be achieved [9]. Nonetheless, the performance of these SOFC cells decreases rapidly, namely about 130%/1000 h, after only 24 hours of use. This degradation is too rapid for transport and even more so for stationary applications. The degradation mechanism was examined and it would seem that the inter-diffusion between the elements of the ferritic steel of the porous substrate and the nickel of the anode play a major role in the strong degradation observed at this temperature.

In documents [10], [11] and [12], the National Research Council of Canada also examined the concept of a metal-supported cell [symbol] MSC [symbol] , in particular by having recourse to Suspension Plasma Spraying (SPS) and to Pulsed Laser Deposition (PLD) to prepare the dense electrolyte. The [symbol] PLD [symbol] method allows dense electrolytes to be obtained of small thickness, namely 20 μm for example, unlike the [symbol] SPS [symbol] technique.

However, the [symbol] PLD [symbol] method has the disadvantage of requiring a vacuum chamber, and the duration of depositing is scarcely compatible with the mass production of cells. In addition, the method for preparing the cell overall requires several heat treatment steps, which means that the cell is economically non-viable.

The German research institute Jülich also focused on the fabrication of [symbol] MSC [symbol] cells, particularly using the thermal spraying method plasma atmospheric spraying [symbol] VPS [symbol] [13] for depositing the anode and electrolyte on the metal support. The performance levels measured on the cells show rapid ageing. The microstructure of the cermet type (NiO/YSZ) anode obtained is far from having triple line density (reaction sites) needed to obtain high electrochemical performance levels.

In document [14], and to develop [symbol] MSC [symbol] cells, the Lawrence Berkeley National Laboratory (LBNL) initially used a method based on co-sintering thin electrode and electrolyte films on a commercially available porous metal support made of ferritic stainless steel pre-sintered at 400° C. under a reducing atmosphere. In this case, the anode (NiO/YSZ) and the electrolyte (YSZ) are deposited using so-called [symbol] wet [symbol] techniques such as tape casting or spraying. The cathode made of LSCF/Pt is applied in the form of a paste and is sintered in situ when heating the cell. Thereafter, as described in document [15], the metal support was optimized and in particular its coefficient of thermal expansion ( [symbol] CTE [symbol] ) by associating with the metal base (Fe30Cr), a ceramic (AlₓTi_{y}O_{z}) with low CTE so as to adjust the global CTE of the metal substrate and ceramic materials with that of the other components of the cell. The method was broken down into 4 steps to assemble the components with one other, each integrating a heat treatment at different temperatures and atmospheric conditions making the production of the cell most cumbersome.

Patents [16], [17] and [18] originating from the work by this laboratory disclose a method for obtaining a dense electrolyte by co-sintering with an air electrode (LSM, LSC, LSCF, SmₓSr_{y}CoO₃, . . . ). Subsequently, this same laboratory conducted researches on another method for fabricating a [symbol] MSC [symbol] cell, to reduce the number of heat treatments for the production thereof. This method of fabrication [19] consists firstly of conducting the co-sintering, at 1300° C. and under a reducing atmosphere, of a multilayer composed of the metal support with a layer of porous zirconia, a layer of dense zirconia and a second layer of porous zirconia. The two porous layers are then infiltrated with precursors of Ni and LSM in solution for the H₂ electrode and the air electrode respectively, and the cell is calcined at 650° C. to convert the precursors to oxide. However in this method, while the number of heat treatment steps is limited, it is necessary to conduct several infiltration-drying cycles to obtain the desired contents of Ni and LSM, which largely contributes to making the method cumbersome. In addition, the nickel particles derived from this method have a very small size of between 40 and 100 nm. This small size, when in operation, translates as rapid ageing of the anode due to the coalescence of the particles and, as a result, to a rapid drop in the electrochemical performance [20]. The cells produced with this method are tubular and of small size having a length of 1 cm and diameter of 1 cm.

The Argonne laboratory has also developed MSC cells having recourse to a co-sintering method of the materials [21]. The metal support is formed by tape casting, and the anode and electrolyte are then successively deposited on the support, drying being carried out after each depositing step. The assembly is then brought to 1300° C. observing a protocol which requires several atmospheres (oxidizing, neutral and reducing) and the cathode (LSCF) is deposited and sintered in situ on start-up of the cell. The main limit of this method is the small size of the cells produced, having a diameter of less than 15 mm, which leads to very low unit energy production for a very high required space per surface unit.

Another possibility to avoid the high sintering temperature is to select suitable materials allowing sintering at lower temperature.

This strategy was adopted by Ceres Power, which developed a technique using a ceria gadolinium oxide (CGO) based electrolyte instead of an yttria-stabilised zirconia (YSZ) based electrolyte. Whereas the sintering temperature of zirconia is about 1350° C., a dense ceria based electrolyte can be obtained by electrolytic deposition then sintering at a temperature of about 1000° C. by adding dopants such as divalent cations e.g. Cu²⁺, Ni²⁺ or Co²⁺ [22]. This company showed that it is possible to fabricate metal-supported SOFC cells using this technique [23], [24].

The proposed method consists of depositing the cathode (LSM, LSCF, GSC, . . . ) and the electrolyte (CGO), for example on a porous metal substrate, by screen printing or tape casting, then sintering the assembly under argon at 950° C., then depositing the anode (NiO/CGO) and sintering the assembly at 1000° C. in a reducing atmosphere. However, even if the densification of the electrolyte proves to be of interest, on account of the use of CGO as electrolyte material, the operating temperature is reduced to 500-600° C. to avoid the electronic conducting nature of CGO which occurs at higher temperatures. This low operating temperature induces less corrosion of the metal support of the cell and of the cell interconnectors, but the resulting performance levels of the cells are therefore fairly low [25], for example of about 300 mW/cm² at 600° C. under hydrogen. In addition, the method requires several heat treatment steps under different neutral or reducing atmospheric conditions.

The DTU-Risoe and Topsoe Fuel Cell (TOFC) companies have also developed cells of [symbol] metal-supported [symbol] type [26] targeting a range of operating temperatures of 600 to 750° C. The electrochemical components of the cell (electrodes and electrolyte) are deposited by spraying, screen-printing or inkjet. However, the thermal consolidation strategy is not specified, nor even the atmospheres used. The metal support has cavities and perforations for feeding of gas.

There is therefore a need, in the light of the preceding study, for metal-supported electrochemical cells able to operate both in fuel cell mode and in electrolyser mode over a range of high temperatures generally from 600 to 1000° C., and which display excellent electrochemical performance levels.

There is in particular a need for a fuel cell whose electrochemical performance is as follows:
In [symbol] SOFC [symbol] fuel cell mode: operating temperature 700° C., power higher than 600 mW/cm².
In high temperature [symbol] HTE [symbol] electrolysis mode: operating temperature 700° C., power greater than 1 W/cm².

There is also a need for said cell which is able to be of significant size, for example equal to or greater than 100 cm² allowing marketing thereof and its integration into power systems.

There is more particularly a need for a cell which, when in operation, does not have the problems frequently encountered with conventional metal-supported cells such as diffusion of the chromium towards the anode causing the poisoning thereof, and diffusion of the nickel towards the metal support with the onset of austenitic phases with high coefficient of thermal expansion.

There is also a need for a method which allows a cell to be prepared having all the above-listed properties, this method being simple, reliable, and advantageous from an economic viewpoint and notably ensuring the assembly of components of different types such as metals, ceramics and cermets.

There is more particularly a need for a method which allows the avoiding of problems frequently encountered when producing a metal-supported cell, such as oxidation of the metal, reducing of the constituent phases of the air electrode, and onset of parasite phases derived from the reaction between the material of the air electrode and the material of the electrolyte such as stabilised zirconia.

The goal of the present invention is to provide a metal-supported electrochemical cell and a method for preparing this cell which inter alia meet the needs set forth above.

A further goal of the present invention is to provide a metal-supported electrochemical cell and a method for preparing this cell which do not have the drawbacks, shortcomings, defects, limitations and disadvantages of metal-supported cells and methods for preparing metal-supported cells of the prior art, and which bring a solution to the problems exhibited the cells and cells preparation methods of the prior art.

### DISCLOSURE OF THE INVENTION

This goal, and others, are achieved according to the invention with a metal-supported electrochemical cell comprising:
a porous metal support (support made of porous metal) comprising a first main surface and a second main surface;
a porous thermomechanical adaptive (matching) layer on said second main surface;
a porous layer, barrier against chromium diffusion, on said porous thermomechanical adaptive (matching) layer, this porous layer, barrier against chromium diffusion being made of stabilised zirconia and/or substituted ceria, and of a mixed oxide of spinel structure;
a porous hydrogen electrode layer on said porous layer, barrier against chromium diffusion;
a dense electrolyte layer on said porous hydrogen electrode layer;
a dense or porous reaction barrier layer on said dense electrolyte layer;
a porous oxygen or air electrode layer on said reaction barrier layer.

Advantageously, the first main surface and the second main surface may be planar, parallel surfaces.

Advantageously, the first main surface may be a lower surface and the second main surface may be an upper (top) surface, and the layers are successively stacked on the second main surface.

In general, the porosity of the porous metal support and of the porous layers may range from 20 to 70%, preferably 20 to 60% by volume, and the porosity of the dense layer(s) such as the electrolyte layer may be less than 6% by volume.

Advantageously, the distance between the first main surface and the second main surface of the porous metal support (support made of porous metal), which can be defined as the thickness of the porous metal support (support made of porous metal), may be equal to or less than 1 mm, preferably it may range from 200 μm to 1000 μm, more preferably from 400 μm to 500 μm.

Advantageously, the porous metal support (support made of porous metal) is made of a metal chosen from among iron, iron-based alloys, chromium, chromium-based alloys, iron-chromium alloys, stainless steels e.g. chromium-forming stainless steels such as the stainless steel referenced K41X produced by ARCELOR MITTAL®, nickel, nickel-based alloys, nickel-chromium alloys, cobalt containing alloys, manganese containing alloys, aluminium containing alloys.

Advantageously, the porous thermomechanical adaptive (matching) layer may be made of a metal, preferably identical to the metal of the porous metal support (support made of porous metal), and of an ion conductor such as stabilised zirconia and/or substituted ceria.

Advantageously the porous hydrogen electrode layer may be made of a mixture of NiO and stabilised zirconia and/or substituted ceria.

Advantageously, the dense electrolyte layer may be made of stabilised zirconia.

Advantageously, the reaction barrier layer may be made of substituted ceria.

Advantageously, the porous oxygen or air electrode layer may be made of substituted ceria and of an oxygen or air electrode material.

The metal-supported electrochemical cell of the invention comprises a specific combination of a metal support and specific layers which has never been described in the prior art.

The electrochemical cell of the invention meets the above-mentioned needs and brings a solution to the aforementioned problems of electrochemical cells of the prior art.

In addition, the electrochemical cell of the invention can be prepared using a simple, reliable and low-cost method.

The invention further concerns a method for preparing a metal-supported electrochemical cell, and in particular a cell such as described above.

Therefore, the invention concerns a method for preparing a metal-supported electrolytic cell comprising:
a porous metal support (support made of porous metal) comprising a first main surface and a second main surface;
a porous thermomechanical adaptive layer, on said second main surface;
optionally a porous layer, barrier against chromium diffusion, on said porous thermomechanical adaptive (matching) layer;
a porous hydrogen electrode layer, on said porous layer, barrier against chromium diffusion;
a dense electrolyte layer, on said porous hydrogen electrode layer;
a dense or porous reaction barrier layer, on said dense electrolyte layer;
a porous oxygen or air electrode layer, on said reaction barrier layer;
   a method in which:

a) a green porous metal support is prepared; then

b) the following are successively deposited in the green state on the second main surface of the green porous metal support:
a porous thermomechanical adaptive layer;
optionally a porous layer, barrier against chromium diffusion;
a porous hydrogen electrode layer;
a dense electrolyte layer;
a dense or porous reaction barrier layer; and
a porous air electrode layer;

c) simultaneous sintering is performed, in a single operation (at once), of the green porous metal support and of all the deposited layers in the green state.

Advantageously, the preparation of the support made of porous metal and the depositing of the layers may be performed using a process chosen from among pressing, hot pressing, tape casting, screen printing, spraying and spin coating.

Advantageously, the sintering step c) is conducted under a controlled atmosphere e.g. a very slightly oxidizing atmosphere.

Advantageously, step c) is conducted at a temperature of 600 to 1600° C., preferably from 800 to 1400° C.

Advantageously, the sintering step c) may comprise a de-binding step in air followed by an actual sintering step under a controlled atmosphere e.g. a very slightly oxidizing atmosphere.

Advantageously, in the method of the invention, the prepared metal-supported electrochemical cell is a cell in which the first main surface and the second main surface may be planar, parallel surfaces.

Advantageously, in the method of the invention, the prepared metal-supported electrochemical cell is a cell in which the first main surface may be a lower surface and the second main surface may be an upper surface, and the layers may be successively stacked on the second main surface.

Advantageously, in the method of the invention, the prepared metal-supported electrochemical cell is a cell in which the porosity of the support made of porous metal and of the porous layers is from 20 to 70%, preferably from 20 to 60% by volume, and the porosity of the dense layer(s) is less than 6% by volume.

Advantageously, in the method of the invention, the prepared metal-supported electrochemical cell is a cell in which the distance between the first main surface and the second main surface of the porous metal support is equal to or less than 1 mm, preferably it is from 200 to 1000 μm, more preferably from 400 to 500 μm.

Advantageously, in the method of the invention, the prepared metal-supported electrochemical cell is a cell in which the porous metal support is made of a metal chosen from among iron, iron-based alloys, chromium, chromium-based alloys, iron-chromium alloys, stainless steels e.g. chromium-forming stainless steels, nickel, nickel-based alloys, nickel chromium alloys, cobalt containing alloys, manganese containing alloys, aluminium containing alloys.

Advantageously, in the method of the invention, the prepared metal-supported electrochemical cell is a cell in which the porous thermomechanical adaptive layer is made of a metal preferably identical to the metal of the support made of porous metal, and of an ion conductor such as stabilised zirconia and/or substituted ceria.

Advantageously, in the method of the invention, the prepared metal-supported electrochemical cell is a cell in which the porous layer, barrier against chromium diffusion, is made of stabilised zirconia and/or substituted ceria, and of a mixed oxide of spinel structure.

Advantageously, in the method of the invention, the prepared metal-supported electrochemical cell is a cell in which the porous hydrogen electrode layer is made of a mixture of NiO and of stabilised zirconia and/or substituted ceria.

Advantageously, in the method of the invention, the prepared metal-supported electrochemical cell is a cell in which the dense electrolyte layer is made of stabilised zirconia.

Advantageously, in the method of the invention, the prepared metal-supported electrochemical cell is a cell in which the reaction barrier layer is made of substituted ceria.

Advantageously, in the method of the invention, the prepared metal-supported electrochemical cell is a cell in which the porous oxygen or air electrode layer is made of substituted ceria and of an oxygen or air electrode material.

The method for preparing a metal-supported electrochemical cell according to the invention comprises a specific combination of specific steps which has never been described in the prior art.

The method for preparing an electrochemical cell according to the invention meets the above-mentioned needs and brings a solution to the aforementioned problems of prior art methods for preparing electrochemical cells.

The method according to the invention differs in particular from the prior art methods in that it comprises a single final heating step during which simultaneous sintering is performed of the support made of green porous metal and of all the deposited green layers. This final sintering step may be called [symbol] co-sintering [symbol] step. This single sintering step allows the assembly in a single operation of the porous metal support and of all the deposited layers.

In the method according to the invention, sintering is not performed on the porous support then on each green layer after the deposition of each of these layers.

The total number of steps of the method is thereby considerably reduced, which leads to reduced costs and shorter duration and makes the method simpler and more reliable.

The method according to the invention ensures the deposition of the layers on the metal support without deterioration of the support, and in particular without modification of the microstructure of this support.

Similarly, the method according to the invention prevents the onset of defects such as cracks and similar in the layers and in particular in the electrolyte layer.

The method according to the invention allows the preparation of cells of significant size and can easily be implemented on a large scale for mass production.

Other effects and advantages of the invention will become better apparent on reading the following detailed description given with reference to the appended drawings in which:

### BRIEF DESCRIPTION OF THE DRAWINGS

FIG. 1 is a schematic vertical cross sectional view of an electrolyte supported cell (“ESC”) of an [symbol] HTE [symbol] or [symbol] SOFC [symbol] ;

FIG. 2 is a schematic vertical cross sectional view of an electrode-supported cell (anode-supported: [symbol] ASC [symbol] in [symbol] SOFC [symbol] terminology, or cathode-supported: [symbol] CSC [symbol] in [symbol] HTE [symbol] terminology) of an [symbol] HTE [symbol] or [ [symbol] SOFC [symbol] ;

FIG. 3A is a schematic vertical cross sectional view of a metal-supported cell (“MSC”) of an [symbol] HTE [symbol] or [symbol] SOFC [symbol] in a first configuration in which the electrode which is placed in contact with the porous metal support is the hydrogen or water electrode;

FIG. 3B is a schematic vertical cross sectional view of a metal-supported cell (“MSC”) of an [symbol] HTE [symbol] or [symbol] SOFC [symbol] in a second configuration in which the electrode which is placed in contact with the porous metal support is the oxygen electrode;

FIG. 4 is a schematic vertical cross sectional view of a cell according to the invention;

FIG. 5 is a graph which shows the dilatometric behaviour of a porous support made of K41X steel.

The dimensional change (displacement) (as a %) is plotted along the Y-axis and the temperature (° C.) is plotted along the X-axis. This figure shows that the coefficient of thermal expansion of the porous support between 300° C. and 800° C. is 11.10⁻⁶/K.

FIG. 6 is a graph showing the dilatometric behaviour of DKKK zirconia having the trade reference 10Sc1CeSZrO.

The dimensional change (displacement) (as a %) is plotted along the Y-axis and the temperature (° C.) is plotted along the X-axis. This figure shows that the coefficient of thermal expansion (CTE) of this zirconia between 300° C. and 1000° C. is 10.10⁻⁶/K.

FIG. 7 is a graph showing the sintering protocol for a cell of the invention, according to the method of the invention.

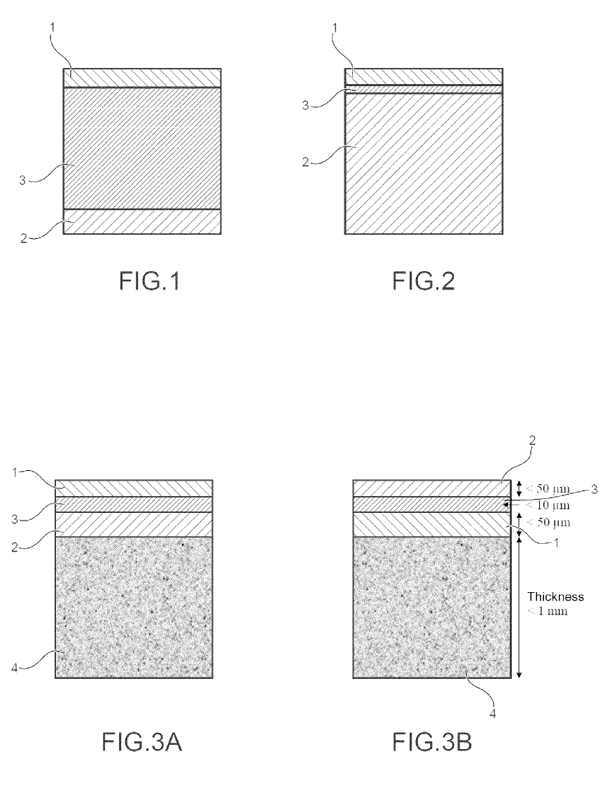

Along the Y-axis are plotted the temperature (in ° C.) on the left and the partial oxygen pressure (in atm) on the right. The time (hours) is plotted along the X-axis. Curve A (solid line) illustrates the trend, evolution in temperature as a function of time, and curve B (dotted lines) illustrates the trend in partial oxygen pressure as a function of time.

### DETAILED DESCRIPTION OF PARTICULAR EMBODIMENTS

The following detailed description is rather more given, for practical reasons, with reference to a method for preparing, fabricating a cell, preferably the cell according to the invention.

Let us first specify that the term porous such as used herein in connection with a material such as a metal or metal alloy, means that this material contains pores or voids.

Thus, the density of this porous material is accordingly lower than the theoretical density of the non-porous material.

In the meaning of the invention, the support or a layer is generally considered to be porous if its density is at most about 92% of its theoretical density.

The pores may be joined together (connected) or isolated, but in the porous metal substrate and in the other porous layers of the cell of the invention, most of the pores are joined (connected) and are in communication. The term open porosity is then used.

More specifically, in the meaning of the invention, a support or layer is generally considered to be porous when its volume porosity is 20 to 70% by volume, preferably 20 to 60% by volume. A layer such as the electrolyte layer is generally considered to be dense when its porosity is less than 6% by volume.

Additionally the terms substrate and support are used indifferently herein, the term support relating rather to the porous substrate integrated or to be integrated in a SOFC or HTE.

Finally, the term [symbol] metal [symbol] herein also covers alloys of metals.

The fabrication of an electrochemical cell according to the invention comprises a first step during which the [symbol] green [symbol] porous metal support is prepared.

The final porous metal support, substrate, after sintering, may have a main section of polygonal shape e.g. a square or rectangular section or a circular section.

The substrate after sintering is generally a flat, planar substrate i.e. the above-mentioned first and second surfaces are generally planar, preferably horizontal and parallel and have for example one of the above-mentioned shapes: polygon, rectangle, square or circle, and in addition the thickness of the substrate is small relative to the dimensions of the said first and second surfaces. Further preferably, the said first and second surfaces are horizontal surfaces and the first main surface can then be qualified as the lower surface whilst the second main surface can then be qualified as the upper surface.

The distance between the first main surface and the second main surface of the support made of porous metal, which can be defined as the thickness of the porous metal support, may be equal to or less than 1 mm, preferably it may be from 200 to 1000 μm, more preferably from 400 to 500 μm.

The substrate after sintering may in particular have the shape of a disc e.g. having a thickness of 200 μm to 2 mm with a diameter of 20 mm to 500 mm, or the shape of a rectangular parallelepiped or of a substrate with square section.

The substrate after sintering may be a substrate of large size, namely with a diameter or sides of 50 mm to 300 mm for example, or a substrate of small size for example of 10 mm to 50 mm.

The metal powders placed in the mould can be chosen from among the powders of the following metals and metal alloys: iron, iron-based alloys, chromium, chromium-based alloys, iron-chromium alloys, stainless steels e.g. chromium-forming stainless steels such as the stainless steel referenced K41X produced by ARCELOR MITTAL®, nickel, nickel-based alloys, nickel chromium alloys, cobalt containing alloys, manganese containing alloys, aluminium containing alloys.

The powders used in the method according to the invention may be commercial powders or else they may be prepared by grinding or atomizing solid pieces of metals or alloys.

The powders of metals or alloys used in the method according to the invention generally have a particle size of 1 μm to 500 μm, preferably 1 μm to 100 μm.

This green, porous metal support may in particular be fabricated by pressing, in particular uniaxial pressing, or by tape casting.

If the porous metal support after co-sintering comprises several layers to impart a gradient of porosity, it is prepared from several tapes by tape casting, these tapes then being assembled by hot pressing or rolling.

When fabricating a porous metal support by uniaxial pressing, the metal or alloy in powder form is optionally mixed with a pore-forming agent and an organic binder, the mixture is fed into a mould of suitable shape and it is then shaped by uniaxial pressing.

The mould is of a shape and size adapted for the shape and size of the substrate it is desired to prepare.

The mould is generally in a metal material.

A porosity gradient may be obtained in the porous metal support by varying the quantity and/or particle size distribution of the pore-forming agent and/or of the metal.

To obtain a porosity gradient in the porous metal support of the invention, it is possible to successively deposit in the mould at least two layers of powder which are of increasing, decreasing particle size, respectively.

Indeed, the greater the particle size of the powder, the greater the size of the pores of the pressed, sintered material derived from this powder.

So, for example, initially a first layer or bottom layer can be deposited in the mould composed of a powder of large particle size, namely of mean size 50 μm to 500 μm for example, in particular of 200 μm which, after compression/pressing and co-sintering, is intended to form in the final porous metal support a bottom layer of large porosity namely a porosity generally of 25% to 65%, advantageously of 30% to 60%. In the final porous metal support, this bottom layer of high porosity allows that the gases be more easily conveyed through the porous body.

The thickness of this bottom layer composed of a powder of large particle size is such that in the final porous body, support, after co-sintering, it gives a layer of high porosity generally having a thickness of 100 μm to 2 mm.

Above this bottom layer composed of a powder of large particle size, a layer can be deposited composed of a powder of small particle size namely of 1 μm to 50 mm for example, in particular of 30 μm which, in the final porous metal support and after compression and sintering, is intended to form a top layer of low porosity, namely a porosity generally of 10% to 40%, advantageously of 20% to 30%. In the final porous metal support, this top layer of low porosity allows the facilitated anchoring of the thermomechanical adaptive layer and the diffusion of gases.

The thickness of this top layer composed of a powder of small particle size is such that, in the final porous support, it gives a layer of low porosity with a thickness of generally less than 200 μm, and preferably less than 100 μm.

Instead of first depositing a bottom layer composed of a powder of large particle size, followed by a top layer composed of a powder of small particle size, it is evidently conversely possible to start by depositing the layer composed of a powder of small particle size, followed by depositing the layer composed of a powder of large particle size.

One or more intermediate layers composed of powders having an intermediate particle size between the particle size of the powder constituting the bottom respectively top layer of large particle size, and the particle size of the powder constituting the top respectively bottom layer of small particle size, may be deposited between the bottom layer and the top layer.

These intermediate layers may be 1 to 8, for example 1 to 5, in particular 2, 3 or 4. The particle size of the powders constituting these intermediate layers is advantageously chosen to ensure a more continuous porosity change in the final porous metal support. In other words, these intermediate layers are composed of powders whose particle size decreases from the layer the closest to the layer composed of a powder of large particle size towards the layer the closest to the layer composed of a powder of small particle size.

Thus, for example, provision may be made for 4 intermediate layers composed of powders respectively having a particle size of 300 to 400, 200 to 300, 100 to 200, 50 to 100 μm between a layer of large particle size generally a particle size between 400 and 500 μm and a layer of small particle size generally having a particle size of 1 to 50 μm.

The exact porosity and thickness of the layers in the final porous metal support are defined by the particle size of the powders and by the force applied during the pressing step described below.

In addition, all the layers of powders including the optional intermediate layers may be composed of one same alloy or metal, or else one or more powder layers may be composed of a metal or alloy different from the other layers.

Once the powder layers have been arranged in the mould, a forming, shaping step of these powders is carried out by pressing, compression. Prior to filling the mould, it is optionally possible to incorporate a binder, such as an organic binder in solution of polyvinyl alcohol type (PVA) and/or a pore-forming agent of starch powder type. These compounds can be added to the metal powder in the form of a suspension or powder (both having a content of 1 to 20%, preferably 3% by weight). The incorporation of the binder allows sufficient mechanical strength to be imparted to the green, pressed parts. The incorporation of the pore-forming agent allows the required final porosity of the material to be reached.

The different layers are deposited by simply pouring them into the mould, and pressing is generally performed on the layer or layers, it also being possible to conduct pressing layer by layer.

Preferably this pressing, this compression is conducted using a uniaxial press.

When pressing, a pressure of between 10 and 500 MPa is generally applied, preferably of 200 MPa to obtain therefore a porosity of 70% to 20%, and preferably of 40% to 60% in the green body.

After the forming step by pressing, compression, a [symbol] green [symbol] porous metal support is obtained having a mean global porosity of 70% to 20%, preferably 40% to 60%. The [symbol] green [symbol] porous metal substrate, support is then released from the mould.

It is also possible to prepare the [symbol] green [symbol] porous metal substrate, support by tape casting one or more tapes, and then optionally assembling these tapes by hot pressing, stamping or rolling.

Hot pressing, under the combined action of temperature and pressure, allows softening of the binders and plasticizers contained in the tapes, ensuring the welding thereof.

The metal in powder form is suspended in an organic solvent, for example Ethanol 2-butanone or Methyl Ethyl Ketone (MEK) or an azeotropic mixture of MEK and ethanol, optionally having recourse to a suitable dispersant such as oleic acid for example. Binders such as polypropylene carbonate or polyvinyl butyral (PVB), and/or plasticizers such as propylene carbonate or polyethylene glycol (PEG) may be added, and optionally a pore-forming agent such as a wax, a starch or polyethylene powder.

The suspension is cast on a suitable support such as a silicon-coated Mylar® sheet in the form of a tape using a casting, shoe reservoir.

Other tapes optionally comprising different amounts and/or particle size distributions of pore-forming agent and/or metal, so as to obtain a porosity gradient after co-sintering, can be cast on the first tape.

Before depositing the layers on the porous metal support, generally the porous metal support is dried.

According to the invention, the different layers intended to form the cell are then successively deposited in the green state on the porous metal support.

Several methods can be envisaged for depositing the different layers and forming the multi-material assembly.

For example, preference is generally given to tape casting for component thicknesses of more than 80 μm, and to screen-printing for smaller thicknesses. However, other processes such as pressing/hot pressing, spraying or spin coating may also be used.

The formulations of the inks or suspension intended for the preparation of the layers (including the porous metal support) generally comprise a solvent, one or more powders of materials constituting the layer, a plasticizer and/or a binder and/or a dispersant. These formulations may also optionally contain added pore-forming agents to maintain sufficient porosity after co-sintering.

To enable the assembly in a single co-sintering step of the green porous support and of the green layers, the coefficients of thermal expansion of the materials constituting the support and the layers over the range of temperatures between ambient temperature and the temperature of thermal consolidation must advantageously be close to one another, and the densification onset temperature thereof must also be close. In addition, the porous support and the different layers must generally exhibit similar shrinkage during the co-sintering heat treatment.

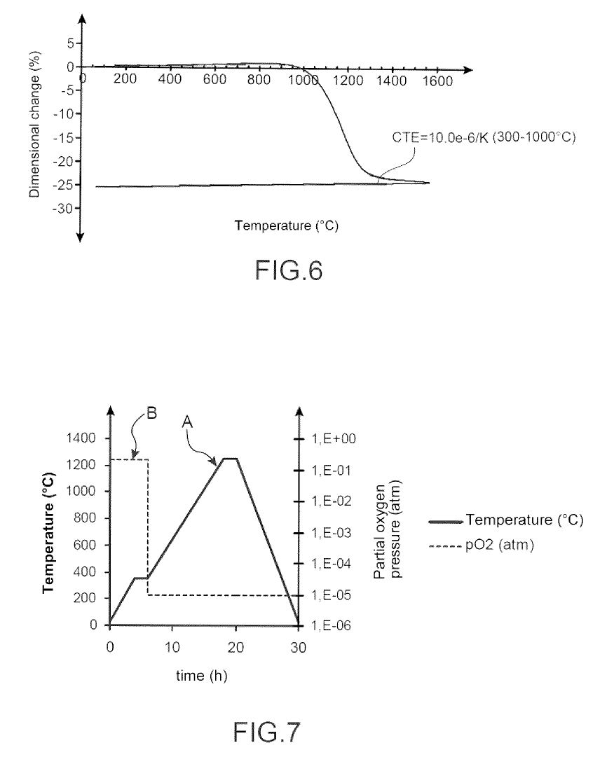

FIGS. 5 and 6 for example show the onset of densification of the metal support and electrolyte at around 1000° C.

More specifically in a second step, it is possible to deposit a porous thermomechanical adaptive layer in the green state on the second main surface of the green porous metal support.

This layer generally comprises a metal that is preferably identical to the metal of the porous metal support, and an ion conductor such as stabilised zirconia and/or substituted ceria which allows the coefficient of thermal expansion of this layer to be adapted to that of the electrolyte whilst maintaining percolation of the metal phase.

The zirconia may be stabilised zirconia, substituted by an oxide chosen from among the oxides of Scandium, Aluminium, Yttrium, Ytterbium, Calcium and Cerium.

Stabilised, substituted ceria is defined below.

This green layer may be prepared using any of the techniques already mentioned above. Preferably, this layer is prepared by serigraphy of a ceramic ink containing a powder of stabilised zirconia, a powder of the metal, a solvent such as terpineol and optionally a plasticizer such as ethylcellulose.

The concentration of the stabilised zirconia and/or of the substituted ceria is generally 10 to 90% by weight, for example 25 weight % of the weight of the ink, and the concentration of the metal is generally 10 to 90% by weight e.g. 20 weight % of the total weight of the ink, the concentration of plasticizer is generally 1 to 10% by weight for example 5% by weight, and the concentration of solvent is generally 30 to 80% by weight, for example 50% by weight.

The deposited layer or tape is generally dried at a temperature of 30 to 120° C., for example 50° C., generally for 1 to 24 hours, for example for 5 hours.

This layer after co-sintering generally has a thickness of 5 μm to 40 μm, for example 20 μm.

In a third step, a green porous layer, barrier against chromium diffusion is optionally deposited on the green porous thermomechanical adaptive layer.

The presence of this layer is preferable, even necessary, in particular if the metal or alloy of the porous metal or alloy support is liable to form chromium when the cell is in operation. In this case, the term chromium-forming metal or alloy is used. Among these chromium-forming alloys, particular mention may be made of chromium stainless steels.

This layer allows trapping of the chromium generated by oxidation and evaporation of the metal or metal alloy of the support when the cell is in operation. Since this chromium diffuses towards the anode, over time it deteriorates the properties thereof.

This layer generally comprises stabilised zirconia identical to that used in the thermomechanical adaptive layer and/or substituted ceria, and a mixed oxide of metals of spinel structure.

The metals of this compound of spinel structure may be chosen from among Mn, Co, Ni and Fe. One example of such a compound of spinel structure is (MnₓCo₃₋ₓ)O₄.

The network of compounds with spinel structure is percolating to ensure electric continuity. These structures react with the Cr, stabilizing the latter in the form of a new spinel structure having a Cr volatility lower than that of the oxide formed on the surface of the metal, whilst displaying good electric conductivity.

The thickness of this layer after co-sintering is generally 5 to 20 μm.

This green barrier layer against diffusion of the chromium may be prepared using any of the techniques already cited above. Preferably, this layer is prepared by screen printing of a ceramic ink comprising a powder of stabilised zirconia similar to that used for preparing the green thermomechanical adaptative layer, a powder of mixed oxides of metals with spinel structure, a solvent such as terpineol and optionally a plasticizer such as ethylcellulose.

The concentration of stabilised zirconia and/or substituted ceria is generally from 10 to 90% by weight, for example 20% by weight of the ink weight, and the mixed oxide concentration of metals with spinel structure, concentration is generally 10 to 90% by weight for example 20 weight % of the total ink weight, the concentration of plasticizer is generally 1 to 10% by weight for example 5% by weight and the concentration of solvent is generally 30 to 80% by weight for example 60% by weight.

The deposited layer or tape is generally dried under the same conditions as the thermo-mechanical adaptive layer.

In a fourth step, a porous hydrogen electrode layer is deposited on the said porous layer, barrier against chromium diffusion.

This layer generally comprises a mixture of stabilised, substituted zirconia similar to that already described above and/or substituted ceria; and NiO.

The stabilised zirconia and/or substituted ceria generally represent 20 to 80% by weight of the layer after co-sintering, and the NiO generally represents 20 to 80% by weight of the layer after co-sintering.

The thickness of this layer after co-sintering is generally 10 to 120 μm, preferably 40 to 120 μm.

This green hydrogen (or water) electrode layer can be prepared using any of the techniques already mentioned above. Preferably, this layer is prepared by serigraphy of a ceramic ink comprising a powder of stabilised zirconia similar to that used to prepare the green thermomechanical adaptive layer, a powder of NiO, a solvent such as terpineol and optionally a plasticizer such as ethylcellulose.

For SOFC functioning mode, with natural gas, the addition of ceria to the zirconia imparts an improved service life (durability) to the cell, in particular with regard to the sulfur compounds contained in natural gas and carbon deposit by coking.

The concentration of stabilised zirconia and/or substituted ceria is generally 20 to 80% by weight for example 30% by weight of the ink weight, and the concentration of NiO is generally 20 to 80% by weight for example 30% by weight of the total ink weight, the concentration of plasticizer is generally 1 to 10% by weight for example 5% by weight and the concentration of solvent is generally 30 to 80% by weight for example 35% by weight.

The deposited layer or tape is generally dried under the same conditions as for the thermo-mechanical adaptive layer and the chromium barrier layer, for example for 5 hours at 50° C.

In a fifth step, an electrolyte layer is deposited on the green hydrogen electrode layer.

The electrolyte layer, after co-sintering, is a dense layer.

This layer generally comprises stabilised zirconia identical to that defined above.

The thickness of this layer after co-sintering is generally 5 to 50 μm, for example 10 μm.

This green electrolyte layer may be prepared using any of the techniques already mentioned above. Preferably, this layer is prepared by screen printing of a ceramic ink comprising a powder of stabilised zirconia similar to that used to prepare the thermo-mechanical adaptive layer, a solvent such as terpineol and optionally a plasticizer such as ethylcellulose.

The concentration of stabilised zirconia is generally 10 to 90% by weight, for example 60% by weight of the weight of the ink, the concentration of plasticizer is generally 1 to 10% by weight for example 5% by weight, and the concentration of solvent is generally 10 to 90% by weight for example 60% by weight.

The deposited layer is generally dried at a temperature of 20 to 160° C., for example at 50° C., generally for 5 minutes to 24 hours, for example for 5 hours.

In a sixth step a green, porous or dense reaction barrier layer is deposited on the dense electrolyte layer. This barrier layer, after co-sintering, prevents the onset of resistive parasite phases such as pyrochlores derived from the reaction between the stabilised zirconia and the material of the air electrode.

This layer generally comprises substituted, stabilised ceria, for example substituted, stabilized with yttrium oxide ( [symbol] YDC [symbol] ) or gadolinium oxide ( [symbol] GDC [symbol] ).

The thickness of this layer after co-sintering is generally 1 to 5 μm, for example 2 μm.

This green reaction barrier layer may be prepared using any of the techniques already cited above. Preferably, this layer is prepared by screen printing of a ceramic ink comprising a powder of stabilised ceria, a solvent such as terpineol and optionally a plasticizer such as ethylcellulose.

The concentration of stabilised ceria is generally 10 to 90% by weight, for example 40% by weight of the ink weight, the concentration of plasticizer is generally 1 to 10% by weight for example 5% by weight, and the concentration of solvent is generally 10 to 90% by weight for example 60% by weight.

The deposited layer is generally dried at a temperature of 20 to 160° C., for example at 50° C., generally for 5 minutes to 24 hours, for example for 5 hours.

In a seventh step, a green oxygen or air electrode layer is deposited on the green porous or dense reaction barrier layer.

This air electrode layer generally comprises a mixture of doped, substituted ceria, doped, substituted, for example with gadolinium oxide (<<GDC>>), and of an air electrode material.

The oxygen or air electrode material may be chosen from among LSC, LSCF, a mixed oxide of perovskite structure having the formula Pr_{0.6}Sr_{0.4}Co_{0.8}Fe_{0.2}O₃ (PSCF) , SmSrCoO₃, Pr₂NiO₄, Nd₂NiO₄, La₂NiO₄, LSM, etc.

This layer, after co-sintering, generally has a thickness of 10 to 80 μm, preferably 20 to 80 μm, for example of 25 μm.

This layer generally has a composition gradient. Said gradient in general is effectively necessary and preferable on account of the difference which may exist between the coefficient of thermal expansion of the electrolyte and the coefficient of the oxygen or air electrode material. The coefficient of thermal expansion of the oxygen or air electrode material is generally higher than the coefficient of the electrolyte and the coefficient of the reaction barrier layer. For example, this coefficient is 19.10⁻⁶ K⁻¹ for PCSF compared with 11.10^{31 6} K⁻¹ for zirconia and 12.10⁻⁶ K⁻¹ for YDC.

By gradient is generally meant that the concentration of doped, substituted ceria e.g. doped with gadolinium oxide decreases in the oxygen or air electrode layer from the side of this layer, or bottom side deposited on the reaction barrier layer, towards, and as far as its other side or top side.

This gradient may be obtained by successively depositing on the reaction barrier layer several layers of same thickness or of different thicknesses e.g. from 2 to 5 layers, with the concentration of doped, substituted ceria e.g. doped with gadolinium oxide decreasing from the first layer deposited on the reaction barrier layer towards as far as the last layer or top layer.

It is possible for example to deposit three successive layers on the reaction barrier layer, with ceria concentrations of 75% by weight, 50% by weight and 25% by weight respectively.

This green oxygen or air electrode layer may be prepared using any of the techniques already mentioned above. Preferably, this layer is prepared by screen printing of a ceramic ink comprising a powder of stabilised ceria similar to that used to prepare the green thermomechanical adaptive layer, and a powder of the oxygen or air electrode material.

If several successive layers are deposited to therefore prepare an oxygen or air electrode material with a gradient, the inks or suspensions used to prepare these successive layers generally have decreasing concentrations of substituted ceria.

The deposited layer is generally dried at a temperature of 20 to 160° C., for example at 50° C., generally for 5 minutes to 24 hours, for example for 5 hours.

On completion of these steps to deposit green layers on the green porous metal support, a green multilayer is obtained which may optionally be cut to the desired shape.

According to the method of the invention, sintering in a single operation and in a single step is then carried out of the assembly formed by the green porous metal support and the green layers deposited on this support. Since this sintering simultaneously concerns the support and all the green layers deposited thereupon, it is called [symbol] co-sintering [symbol] .

Co-sintering is preferably conducted under a controlled atmosphere, namely a very slightly oxidizing atmosphere, generally defined by a very low partial oxygen pressure for example less than 10⁻⁵ atm, preferably of less than 10⁻²⁰ atm, to limit the oxidation of this porous body. This atmosphere is generally composed of an inert gas, argon or nitrogen, in the presence of a reducer such as hydrogen, or it is composed of pure hydrogen.

The co-sintering is generally conducted at a temperature of between the minimum temperature for initiating sintering and the total densification temperature of the material constituting the [symbol] green [symbol] porous support. This temperature is generally between 600° C. and 1600° C. and more specifically between 800° C. and 1400° C., in particular for K41X steel.

The sintering temperature can be maintained (sintering plateau, hold) for a time of 0 to 8 hours, for example 3 hours.

The choice of the densification-sintering temperature and the duration of the sintering, plateau, hold are determined by the desired global, mean, final porosity of the support material and of the porous layers, and preferably a sintering temperature of 1200° C. is chosen which is held for a time of 3 hours.

The thermal co-sintering cycle may comprise two separate successive steps:
a first step or de-binding step, may be conducted in air for example, from ambient temperature up to a temperature of 350° C. to 450° C. which is a temperature at which the metal support does not exhibit any significant oxidation.

For example a temperature rise may be carried out from ambient temperature up to a temperature of between 350° C. and 450° C. at a rate of 0.5° C./min, followed by a plateau, hold at this temperature between 350° C. and 450° C. for a time of 1 to 12 hours (see FIG. 7).
a second step, which is the actual sintering step, is conducted for example up to 1200° C. under a controlled, very slightly oxidizing atmosphere such as defined above, which makes it possible not to reduce the crystalline phases of the air electrode and of the optional Cr diffusion barrier layer and to avoid significant oxidation of the support metal.

For example, the temperature can be raised from the de-binding plateau, hold temperature, between 350° C. and 450° C., at the rate of 2° C./min up to 1200° C., followed by a plateau, hold at this temperature for a time of 3 to 10 hours (see FIG. 7).

The temperature is then lowered from 1200° C. down to ambient temperature at the rate of 0.1 to 5° C./min (see FIG. 7).

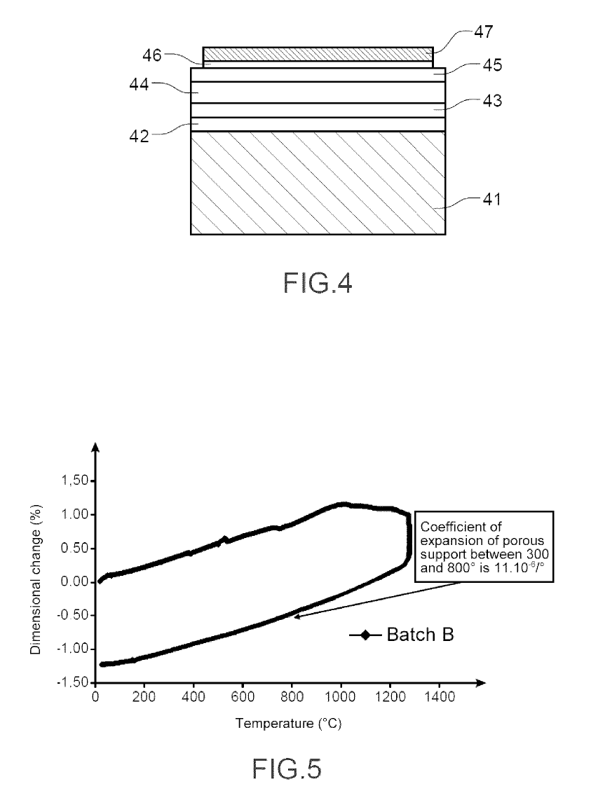

A cell, in particular a cell of the invention obtained using the method of the invention is illustrated in FIG. 4.

It is a cell of SOFC type. The cell of electrolyser type for example of steam electrolyser type is designed with a stack of similar layers prepared following an identical protocol.

In this respect, it may be noted that the present description applies to any cell whether a “SOFC” cell or “HTE” cell. The necessary adaptations for each type of cell and their method of fabrication are within easy reach of the man skilled in the art.

It comprises a porous metal support (41), a thermomechanical adaptive layer (42), a chromium diffusion barrier layer (optional) (43), a hydrogen or water electrode (44), a dense electrolyte (45), a reaction barrier layer (46), and an oxygen or air electrode (47).

The [symbol] SOFC [symbol] comprising a cell according to the invention finds in particular application in the field of micro-cogeneration. It is possible for example to use this cell architecture in a fuel cell supplied with town natural gas and integrated in an individual boiler for the simultaneous production of electricity and heat.

A [symbol] SOFC [symbol] comprising a cell according to the invention may also function with a supply of biogas derived for example from the treatment of waste from landfills or (wastewater) treatment plants, or with gas derived from the treatment of various effluent e.g. from the paper or dairy industries.

A description of the invention will now be given with reference to the following example given as a non-limiting illustration.

In this example a metal-supported electrochemical cell is prepared, in particular a cell according to the invention as illustrated in FIG. 4, using the method of the invention.

### 1/ Metal Support

The metal support is formed by tape casting from a ferritic stainless steel of reference K41X (European designation X2CrTiNb18 1.4509) produced by ARCELOR MITTAL®.

A first suspension is prepared with a coarse steel powder having a median size centred on 200 μm.

The casting suspension is then prepared with the following composition: 82% by weight of metal, 13% by weight of 2-butanone (solvent), 3.5% by weight of polypropylene carbonate (binder) and 0.5% by weight of propylene carbonate (plasticizer). This suspension is cast on a silicon-coated Mylar® sheet using a casting, shoe reservoir, placed at a casting height of 700 μm. After drying at ambient temperature for 5 hours, a second tape is cast on the first using a second suspension having the same formulation as the preceding suspension but made from a finer steel powder with a median size centred on 30 μm.

2/ Thermomechanical Adaptive Layer.

A layer of small thickness (20 μm) is deposited by screen printing of a ceramic ink on the preceding green tape.

The composition of this ink is as follows: 25% by weight of zirconia stabilised with scandium and cerium (10Sc1CeSZrO) produced by DAIICHI KIGENSO KAGAKU KOGYO with particle size centred on 0.5 μm, 20% by weight of steel powder centred on 10 μm, 5% by weight of ethyl cellulose (plasticizer) and 50% by weight of terpineol (solvant). The tape is then dried at 40° C. for 5 hours.

3/ Optional Chromium Anti-Diffusion Barrier Layer

Especially, in the case in which the type of metal used to form the support is a chrome-forming metal, a layer is added to stop the diffusion of chromium towards the H₂ electrode.

This layer having a thickness of 15 μm is deposited by screen printing on the green tape previously obtained from a ceramic ink. This ink is prepared with the following composition: 20% by weight of stabilised zirconia identical to that used for the thermomechanical adaptive layer, 20% by weight of a mixed oxide of spinel type (MnₓCo₃₋ₓ)O₄ capable of fixing the Cr and produced by MARION TECHNOLOGY® having a particle size centred on 1 μm, 5% ethyl cellulose and 55% terpineol. The drying step is identical to the preceding step.

4/ H₂ Electrode

The H₂ electrode having a thickness of 40 μm is prepared by screen printing on the green tape obtained at the end of the preceding step, using an ink composed of 30% by weight of stabilised zirconia identical to that previously used, 30% by weight of NiO produced by Pharmacie Centrale de France having a particle size centred on 5 μm, 5% ethyl cellulose and 35% terpineol. Drying is conducted for 5 hours at 40° C.

### 5/ Electrolyte

The thin electrolyte of 10 μm is formed by serigraphy on the preceding green tape. The deposited ink is composed of 60% by weight of stabilised zirconia identical to that used in step 2, 5% by weight of ethyl cellulose and 55% by weight of terpineol.

6/ Reaction Barrier Layer

To prevent any reactivity between the zirconia of the electrolyte and the air electrode material, an yttrium-oxide substituted ceria based layer (YDC) of 2 μm is deposited by serigraphy on the green tape obtained at the end of the preceding step.

The formulation of the ink is 60% by weight of ceria (YDC) produced by MARION TECHNOLOGY® whose particle size is centred on 0.5 μm, 5% by weight of ethyl cellulose and 55% by weight of terpineol. Drying is conducted under the same conditions as for the preceding step.

7/ Oxygen or Air Electrode

The oxygen or air electrode is composed of a mixed oxide of perovskite structure having the formula Pr_{0.6}Sr_{0.4}Co_{0.8}Fe_{0.2}O₃ (PSCF) associated with gadolinium oxide-substituted ceria ( [symbol] GDC [symbol] ). On account of a higher coefficient of expansion than that of the electrolyte and reaction barrier layer (19.10⁻⁶ K⁻¹ for PSCF against 11.10⁻⁶ K⁻¹ for zirconia and 12.10⁻⁶ K⁻¹ for [symbol] YDC [symbol] ), the oxygen or air electrode is prepared with an architecture having a composition gradient.

This electrode therefore comprises a 5 μm layer of a mixture of 75% by weight of CGO and 25% by weight of PSCF, a 10 μm layer of a mixture of 50% by weight of CGO and 50% by weight of PSCF, and a 10 μm layer of a mixture of 25% by weight of CGO and 75% by weight of PSCF. The assembly of layers is deposited by screen printing on the green tape obtained at the end of the preceding step. The drying of the different layers is conducted for 5 hours at 40° C.

On completion of this forming, the multilayer is cut to the desired shape and then sintered under the conditions set forth in FIG. 7 which illustrates the cell sintering protocol.

The sintering cycle is broken down into 2 separate phases, the first phase reserved for de-binding is conducted in air at up to 350° C., and the second which concerns the sintering of the cell is conducted under argon containing 10⁻⁵ atm oxygen.

### REFERENCES

[1] S. J. Visco, Craig P. Jacobson, L. C. De Jonghe, LBNL Activity Overview, Presented at the SECA Workshop, Feb. 20, 2003.

[2] G. Schiller, A. Ansar, M. Lang, O. Patz, “High temperature water electrolysis using metal-supported solid oxide electrolyser cells (SOEC), J. Appl Electrochem (2009) 39:293-301

[3] G. Schiller, et al., “Development of plasma sprayed components for a new SOFC design”, SOFC V, Electrochemical proceedings Vol 97-18 (1997), 635-644

[4] G. Schiller, R. Henne, M. Lang, S. Schaper, “Development of metallic substrate supported thin film sofc by applying vacuum spray techniques”, Electrochemical Proceedings Vol 99-19, 1999.

[5] P. Szabo, et al., “Measurements of high temperature leak rates on vacuum-plasma sprayed SOFC electrolytes”, 7th European SOFC forum, Luzern 3-7 Jul. 2006 (2006), P0419.

[6] T. Franco, M. Lang, G. Schiller, P. Szabo, W. Glatz, G. Kunschert, “Power metallurgy high performance materials for substrate-supported IT-SOFCs”, Proc. 6th European SOFC forum, Luzern (2004), 209-216.

[7] R. Vassen et al., “Gas-tight zirconia electrolyte layers for SOFCs by atmospheric plasma spraying”, SOFC IX, Electrochemical Society Proceedings, Vol 2005-07 (2005), 1016-1024.

[8] R. Vassen et al., “Gas-tight zirconia electrolyte layers for SOFCs by atmospheric plasma spraying”, SOFC IX, Electrochemical Society Proceedings, Vol 2005-07 (2005), 1016-1024.

[9] R. Vassen et al., “Development of gas-tight zirconia electrolyte layers using atmospheric plasma spraying”, 207th ECS Meeting—Quebec City, Canada, May 2005.

[10] S. R. Hui et al., Journal of Power Sources 167 (2007) 336-339.

[11] Q. Huang et al., Journal of Power Sources 177 (2008) 339-347.

[12] Z. Wang et al., Journal of Power Sources 176 (2008) 90-95.

[13] D. Hathiramani et al., “Degradation mechanism of metal supported atmospheric plasma sprayed solid oxide fuel cells”, 30th Int. Conf. Adv. Ceram. Composites (2006).

[14] I. Villareal et al., “Metal supported solid oxide fuel cells”, Electrochem. Sol. State Letters, Vol 6, Iss. 9 (2003) A178-179.

[15] Y. B. Matus, L. C. De Jonghe, C. P. Jacobson, S. J. Visco, Solid State Ionics 176 (2005) 443-449.

[16] C. P. Jacobson, S. J. Visco, L. C. De Jonghe, U.S. Pat. No. B2-6,921,557.

[17] S. J. Visco, C. P. Jacobson, L. C. De Jonghe, U.S. Pat. No. B2-7,118,777.

[18] L. C. De Jonghe, C. P. Jacobson, S. J. Visco, U.S. Pat. No. B2-7,351,488.

[19] M. C. Tucker, G. Y. Lau, C. P. Jacobson, L. C. De Jonghe, S. J. Visco, Journal of Power Sources 171 (2007) 477-482

[20] M. C. Tucker, G. Y. Lau, C. P. Jacobson, L. C. De Jonghe, S. J. Visco, Journal of Power Sources 175 (2008) 447-451

[21] J. D. Carter, D. Myers, R. Kumar, “Recent progress on the development of Tuffcell, a metal supported SOFC/SOEC”, The 30th International conference & Exposition on advances ceramics and composites, 2006.

[22] Ceres Power LTD, GB-A-2 400 486, “Densification of ceria based electrolytes”.

[23] Ceres Power LTD, U.S. Pat. No. B2-6,794,075.

[24] Ceres Power LTD, WO-A2-03/075382.

[25] P. Attryde et al., “Stacks and systems based around metal supported SOFCs operating at 500-600° C.” SOFC IX, Electrochemical Society Proceedings, Vol 2005-07 (2005), 113-122.

[26] N. Christiansen, J. Norsk, EP-A-1353394.

1. A metal-supported electrochemical cell comprising:
a porous metal support comprising a first main surface and a second main surface;
a porous thermomechanical adaptive layer, on said second main surface;
a porous layer, barrier against chromium diffusion, on said porous thermomechanical adaptive layer, this porous layer, barrier against chromium diffusion, being made of stabilised zirconia and/or of substituted ceria, and of a mixed oxide of spinel structure;
a porous hydrogen electrode layer, on said porous layer, barrier against chromium diffusion;
a dense electrolyte layer, on said porous hydrogen electrode layer;
a dense or porous reaction barrier layer, on said dense electrolyte layer;
a porous oxygen or air electrode layer, on said reaction barrier layer.

2. The metal-supported electrochemical cell according to claim 1, wherein the first main surface and the second main surface are planar, parallel surfaces.

3. The metal-supported electrochemical cell according to claim 2, wherein the first main surface is a lower surface and the second main surface is an upper surface, and the layers are successively stacked on the second main surface.

4. The metal-supported electrochemical cell according to claim 1, wherein a porosity of the porous metal support and of the porous layers is 20 to 70% by volume, and a porosity of the dense layer(s) is less than 6% by volume.

5. The cell according to claim 1, wherein a distance between the first main surface and the second main surface of the porous metal support is equal to or less than 1 mm.

6. The cell according to claim 1, wherein the porous metal support is made of a metal selected from the group consisting of iron, iron-based alloys, chromium, chromium-based alloys, iron-chromium alloys, stainless steels for example chromium-forming stainless steels, nickel, nickel-based alloys, nickel chromium alloys, cobalt containing alloys, manganese containing alloys, and aluminium containing alloys.

7. The cell according to claim 1, wherein the porous thermomechanical adaptive layer is made of a metal and of an ion conductor.

8. The cell according to claim 1, wherein the porous hydrogen electrode layer is made of a mixture of NiO, and of stabilised zirconia and/or substituted ceria.

9. The cell according to claim 1, wherein the dense electrolyte layer is made of stabilised zirconia.

10. The cell according to claim 1, wherein the reaction barrier layer is made of substituted ceria.

11. The cell according to claim 1, wherein the porous oxygen or air electrode layer is made of substituted ceria and of an oxygen or air electrode material.

12. A method for preparing a metal-supported electrochemical cell comprising:
a porous metal support comprising a first main surface and a second main surface;
a porous thermomechanical adaptive layer, on said second main surface;
optionally a porous layer, barrier against chromium diffusion, on said porous thermomechanical adaptive layer;
a porous hydrogen electrode layer, on said porous layer, barrier against chromium diffusion;
a dense electrolyte layer, on said porous hydrogen electrode layer;
a dense or porous reaction barrier layer, on said dense electrolyte layer;
a porous oxygen or air electrode layer, on said reaction barrier layer;
a method in which:
a) a green porous metal support is prepared; then
b) the following are successively deposited in the green state on the second main surface of the green porous metal support:
a porous thermomechanical adaptive layer;
optionally a porous layer, barrier against chromium diffusion;
a porous hydrogen electrode layer;
a dense electrolyte layer;
a dense or porous reaction barrier layer; and
a porous oxygen or air electrode layer;
c) simultaneous sintering, in a single operation, of the green porous metal support and of all the deposited layers in the green state, is carried out.

13. The method according to claim 12, wherein the layers are deposited using a process selected from the group consisting of screen printing, tape casting, pressing, hot pressing, spraying and spin coating.

14. The method according to claim 12, wherein the sintering step c) is conducted under a controlled atmosphere.

15. The method according to claim 12, wherein the sintering step c) is conducted at a temperature of 600° C. to 1600° C.

16. The method according to claim 12, wherein the sintering step c) comprises a de-binding step in air followed by a sintering step properly so-called under a controlled atmosphere.

17. The metal-supported electrochemical cell according to claim 1, wherein a porosity of the porous metal support and of the porous layers is 20 to 60% by volume, and a porosity of the dense layer(s) is less than 6% by volume.

18. The cell according to claim 1, wherein a distance between the first main surface and the second main surface of the porous metal support is from 200 to 1000 μm.

19. The cell according to claim 1, wherein a distance between the first main surface and the second main surface of the porous metal support is from 400 to 500 μm.

20. The cell according to claim 7, wherein the porous thermomechanical adaptive layer is made of a metal that is identical to the metal of the porous metal support.

21. The cell according to claim 7, wherein the ion conductor is stabilised zirconia and/or substituted ceria.

22. The cell according to claim 14, wherein the controlled atmosphere is a very slightly oxidizing atmosphere.

23. The method according to claim 12, wherein the sintering step c) is conducted at a temperature of 800° C. to 1400° C.

24. The cell according to claim 16, wherein the controlled atmosphere is a very slightly oxidizing atmosphere.
